(19) United States
(12) Patent Application Publication
(10) Pub. No.: US 2022/0344739 A1
(43) Pub. Date: Oct. 27, 2022

(54) ELECTRIC VEHICLE BATTERY CASE AND METHOD FOR MANUFACTURING THE SAME

(71) Applicant: KABUSHIKI KAISHA KOBE SEIKO SHO (KOBE STEEL, LTD.), Hyogo (JP)

(72) Inventor: Hideki ISHITOBI, Kobe-shi, Hyogo (JP)

(73) Assignee: KABUSHIKI KAISHA KOBE SEIKO SHO (KOBE STEEL, LTD.), Hyogo (JP)

(21) Appl. No.: 17/640,308

(22) PCT Filed: Sep. 3, 2020
(86) PCT No.: PCT/JP2020/033472

§ 371 Date: Mar. 3, 2022

(30) Foreign Application Priority Data
Oct. 10, 2019 (JP) 2019-186807

(51) Int. Cl. H01M 10/625; H01M 10/613; H01M 10/6556; H01M 50/249

(52) U.S. Cl. CPC H01M 10/625; H01M 10/613; H01M 10/6556; H01M 50/249; H01M 2220/20

(57) ABSTRACT

An electric vehicle battery case 100 includes: a tray including a placement portion on which a battery is placed and having a groove formed in a bottom portion of the placement portion; a closing plate joined to the tray to close the groove and define a coolant flow path; and a top cover configured to seal the placement portion of the tray.

### TECHNICAL FIELD

The present invention relates to an electric vehicle battery case and a method for manufacturing the same.

### BACKGROUND ART

An electric vehicle such as an electric car needs to mount with a large capacity battery in order to secure a sufficient cruising distance, and on the other hand, the electric vehicle is required to include a wide vehicle interior. In order to satisfy these requirements, in many electric cars, a large-capacity battery is stored in a battery case and mounted on the entire underfloor surface of the vehicle. Therefore, the electric vehicle battery case is required to have high sealing performance for preventing water from entering from a road surface or the like to prevent malfunctions of electronic components, and is also required to have cooling performance capable of efficiently cooling a large-capacity battery.

For example, Patent Document 1 discloses a battery module in which a water-cooled cooler is disposed below a battery case. In order to cool a battery as in the battery module, a cooling structure is generally configured separately from the battery case.

### PRIOR ART DOCUMENT

### Patent Document

Patent Document 1: JP 2018-163741 A

### SUMMARY

### Problems to be Solved by the Invention

However, when a cooling structure is configured separately from the battery case as in Patent Document 1, the number of components may increase, and the space required for the battery module may increase. In addition, since the cooling structure is configured separately from the battery case, there is room for improvement also from the viewpoint of cooling efficiency.

An object of the present invention is to improve space efficiency and cooling performance in an electric vehicle battery case and a method for manufacturing the same.

### Means for Solving the Problems

A first aspect of the present invention provides an electric vehicle battery case including: a tray including a placement portion on which a battery is placed and having a groove formed in a bottom portion of the placement portion; a closing plate joined to the tray to close the groove and define a coolant flow path; and a top cover configured to seal the placement portion of the tray.

According to this configuration, since the coolant flow path is formed in the bottom portion of the placement portion of the tray, the battery placed on the placement portion can be efficiently cooled. In addition, since the coolant flow path is formed in the bottom portion of the battery case itself, it is not necessary to configure a cooler as a separate component. That is, since the battery case and the cooler can be integrated, space efficiency can be improved. In addition, since the placement portion of the tray is hermetically sealed by the top cover, high sealing performance capable of preventing water from entering from a road surface or the like can be secured.

The coolant flow path may include an inlet, an outlet, an inflow path extending from the inlet, an outflow path extending to the outlet, and a branch path branching from the inflow path and joining at the outflow path. The inflow path may have a larger flow path area than the branch path. The outflow path may have a larger flow path area than the branch path.

According to this configuration, the flow of the coolant in the coolant flow path can be made uniform. The coolant flows through the inlet, the inflow path, the branch path, the outflow path, and the outlet in this order. Since the branch path branches from the inflow path, the inflow path has a flow path area larger than that of the branch path, thereby reducing a flow rate change due to the branching. In addition, since the branch path joins the outflow path, the outflow path has a larger flow path area than the branch path, thereby reducing a flow rate change due to the joining.

The flow path area of the inflow path may decrease from the inlet toward the outlet. The flow path area of the outflow path may increase from the inlet toward the outlet.

According to this configuration, the flow of the coolant in the coolant flow path can be further made uniform. In addition, in the coolant flow path, the flow rate of the inflow path decreases every time the branch path branches from the inflow path. Therefore, reducing the flow path area of the inflow path from the inlet toward the outlet in accordance with the flow rate reduction due to the branching makes the flow of the coolant uniform. In addition, in the coolant flow path, the flow rate of the outflow path increases every time the branch path joins the outflow path. Therefore, increasing the flow path area of the outflow path from the inlet toward the outlet in accordance with the flow rate increase due to the joining makes the flow of the coolant uniform.

The placement portion may be divided by a projecting portion having a bottom surface partially projecting upward and extending in a vehicle width direction. Each obtained by dividing the placement portion may be provided with an inlet and an outlet of the coolant flow path.

According to this configuration, since the coolant flow path is individually provided for the battery placed on each of the divided placement portions, the cooling amount of the individual battery can be made uniform. In particular, in a vehicle, since a framework member extending in the vehicle width direction such as a cross member may be disposed for improving strength, a design avoiding the cross member such as the projecting portion may be made. In such a case, since the battery is also divided into a plurality of cells, it is effective that the cooling amount of an individual battery can be made uniform.

A second aspect of the present invention provides a method for manufacturing an electric vehicle battery case, the method including: preparing a tray including a placement portion on which a battery is placed and having a groove formed in a bottom portion of the placement portion; and disposing and joining a closing plate to the tray to close the groove and define a coolant flow path.

According to this method, since the coolant flow path is formed in the bottom portion of the placement portion of the tray, the battery placed on the placement portion can be efficiently cooled. In addition, since the coolant flow path is formed in the bottom portion of the battery case itself, it is not necessary to configure a cooler as a separate component. That is, since the battery case and the cooler can be integrated, space efficiency can be improved. In addition, high sealing performance may be secured by hermetically sealing the tray with the top cover as described above.

The preparing a tray may include: forming the placement portion having a recessed shape in a blank material having a flat plate shape, and forming the groove in the bottom portion of the placement portion.

According to this method, since the placement portion on which the battery is placed is formed in a recessed shape, the battery can be housed in the placement portion. In particular, since both the placement portion and the groove are to be formed in a recessed shape, the placement portion and the groove can be formed by cold press forming and pressure forming as described below.

The preparing a tray may include: forming the placement portion in the blank material by first cold press forming, and forming the groove in the bottom portion of the placement portion by second cold press forming.

According to this method, the tray is formed by two-stage cold press forming of first and second cold press forming. In the cold press forming, although depending on the machinability of the material, it is difficult to simultaneously form a large recessed shape such as the placement portion and a small recessed shape such as the groove with high accuracy. Thus, by performing these pieces of forming in two stages, forming with different machining accuracy can be stably achieved.

Softening heat treatment may be performed on the blank material between the first cold press forming and the second cold press forming.

According to this method, by the softening heat treatment, it is possible to remove the machining distortion of the blank material that may be caused by the first cold press forming. Accordingly, since the elongation of the material is recovered, the roundness of the ridgeline portion or the corner portion of the tray can be further reduced in the second cold press forming.

The preparing a tray may include: forming the placement portion in the blank material and forming the groove in the bottom portion of the placement portion by a pressure forming method.

The pressure forming method makes it possible to omit the draft angle (inclination of the side surface), which is difficult in normal cold press forming, and to reduce the roundness of the ridgeline portion or the corner portion, and to be formed into a tray having any shape. As described above, omitting the draft angle and reducing the roundness of the ridgeline portion allows the space efficiency of the battery case to be improved and the battery having a larger capacity to be mounted. Here, the pressure forming method refers to a method of forming a member by gas or liquid pressure.

The preparing a tray may include: forming the placement portion in the blank material by cold press forming, and forming the groove in the bottom portion of the placement portion by a pressure forming method.

According to this method, a large recessed shape such as the placement portion can be easily formed by cold press forming, and a small recessed shape such as the groove can be accurately formed by pressure forming method. Therefore, stable forming of the blank material can be achieved.

The pressure forming method may include: superposing and disposing a hydraulic transfer elastic body configured to be elastically deformed on the blank material using pressure of liquid, and pressurizing the blank material via the hydraulic transfer elastic body.

According to this method, the liquid to which pressure is applied does not scatter or leak when the blank material is formed. Here, for example, the hydraulic transfer elastic body may have a structure in which only a lower surface of a metal chamber containing a liquid is closed with a rubber plate. The rubber plate is elastically deformed by adjusting the pressure of the liquid, and forming can be performed without the liquid coming into direct contact with the blank material. If the hydraulic transfer elastic body is not used in the pressure forming method, since the blank material is directly deformed by a fluid held at a high pressure, it is necessary to strongly constrain the outer edge portion of the blank material so that the fluid does not scatter or leak to the outside. However, when the hydraulic transfer elastic body is used, since the liquid to which the force is applied does not scatter or leak, the constraint force on the outer edge portion of the blank material can be reduced. Therefore, when the blank material is formed, the material amount flowing from the outer edge portion to the inside can be increased, and stable machining can be achieved by suppressing cracking or the like of the blank material. In addition, since it is not necessary to completely seal the outer edge portion of the blank material, maintenance of the die and the pressing machine for constraining the outer edge portion becomes easy, and productivity can be improved.

The method for manufacturing an electric vehicle battery case may further include preparing a frame configured to define a space inside the frame. The preparing a tray may further include: superposing and disposing the blank material on the frame, pressurizing and pressing the blank material against the frame to swell the blank material into the space so as to form the blank material into the tray integrated with the frame.

According to this method, the blank material can be formed into the tray and can be integrated with the frame at the same time. Since the blank material having a flat plate shape is formed into the tray, there is no seam, and high sealing performance can be secured. In addition, since the blank material is formed into the tray and joined to the frame at the same time, the joining step can be simplified. Since the blank material is joined by press-fitting to the frame instead of welding, it is possible to achieve highly accurate joining without causing thermal deformation. Therefore, in the method for manufacturing an electric vehicle battery case, sufficient sealing performance of the battery case can be secured, and the frame and the tray can be easily and accurately joined.

The preparing a tray may further include performing negative angle forming of at least partially forming a negative angle upward from the bottom portion of the tray.

According to this method, since the negative angle is formed in the tray, it is possible to prevent the joining by press-fitting with the frame from being released by the negative angle portion. Here, the negative angle is a term often used in the forming field using a die, and indicates that the die draft angle in the formed member is less than zero (negative). For example, the negative angle portion of the tray may be formed by forming the inner surface of the frame (including the cross member) into a negative angle shape and pressing the tray against the frame. As the negative angle shape of the inner surface of the frame, a recessed shape (recess) may be provided on the inner surface of the lower portion or the central portion in the vehicle width direction of the frame. The joining strength between the frame and the tray is increased by this negative angle forming. In particular, the negative angle forming is effective forming for a pressure forming method because in cold press forming requiring a draft angle using a normal die, there is a problem that a cam mechanism needs to be added and a die structure becomes complicated.

The method for manufacturing an electric vehicle battery case may further include preparing a constraining die having a height dimension equal to or larger than a height dimension of the frame and configured to constrain movement of the frame. The preparing a tray may further include: fixing and disposing the constraining die outside the frame, supporting a first outer edge portion of the blank material with the frame and supporting a second outer edge portion outside the first outer edge portion with the constraining die to bend and dispose the blank material so that a height of the blank material decreases from an outer side toward an inner side, and pressurizing the blank material in a state where the blank material is bent to form the blank material into the tray.

According to this method, since the blank material is pressurized in a state where the blank material is bent so that the height decreases from the outside toward the inside, the amount of the material flowing into the inside of the blank material can be increased, and a shape in which the roundness of the ridge line portion or the corner portion of the bottom portion of the tray is further reduced can be achieved.

### Effect of the Invention

According to the present invention, in an electric vehicle battery case and a method for manufacturing the same, since the coolant flow path is integrally formed in the bottom portion of the placement portion of the tray, improvement in space efficiency and cooling performance can be achieved.

### BRIEF DESCRIPTION OF THE DRAWINGS

FIG. 1 is a side view of an electric car mounting an electric vehicle battery case according to a first embodiment of the present invention;

FIG. 2 is a schematic cross-sectional view of a battery case in the first embodiment;

FIG. 3 is a perspective view of a tray, a frame, and a closing plate in the first embodiment;

FIG. 4 is an exploded perspective view of a tray, a frame, and a closing plate in the first embodiment;

FIG. 5 is a plan view of a tray in the first embodiment;

FIG. 6 is a first cross-sectional view showing a method for manufacturing the battery case according to the first embodiment;

FIG. 7 is a second cross-sectional view showing a method for manufacturing the battery case according to the first embodiment;

FIG. 8 is a third cross-sectional view showing a method for manufacturing the battery case according to the first embodiment;

FIG. 9 is a fourth cross-sectional view showing a method for manufacturing the battery case according to the first embodiment;

FIG. 10 is a cross-sectional view showing a first modification of negative angle forming;

FIG. 11 is a cross-sectional view showing a first modification of negative angle forming;

FIG. 12 is a cross-sectional view showing a third modification of negative angle forming;

FIG. 13 is a schematic cross-sectional view of a battery case showing a modification of the closing plate;

FIG. 14 is a perspective view of a constraining die and a frame in a second embodiment;

FIG. 15 is an exploded perspective view of a constraining die and a frame in the second embodiment;

FIG. 16 is a first cross-sectional view showing a method for manufacturing a battery case according to the second embodiment;

FIG. 17 is a second cross-sectional view showing a method for manufacturing a battery case according to the second embodiment;

FIG. 18 is a third cross-sectional view showing a method for manufacturing a battery case according to the second embodiment;

FIG. 19 is a fourth cross-sectional view showing a method for manufacturing a battery case according to the second embodiment;

FIG. 20 is a cross-sectional view showing a modification of the method for manufacturing a battery case according to the second embodiment;

FIG. 21 is a first cross-sectional view showing a method for manufacturing a battery case according to a third embodiment;

FIG. 22 is a second cross-sectional view showing the method for manufacturing a battery case according to the third embodiment;

FIG. 23 is a third cross-sectional view showing the method for manufacturing a battery case according to the third embodiment;

FIG. 24 is a fourth cross-sectional view showing the method for manufacturing a battery case according to the third embodiment;

FIG. 25 is a perspective view of a tray, a frame, and a closing plate of a battery case according to a fourth embodiment;

FIG. 26 is an exploded perspective view of a tray, a frame, and a closing plate in the fourth embodiment;

FIG. 27 is a plan view of a tray in the fourth embodiment;

FIG. 28 is a schematic cross-sectional view of a battery case according to another modification;

FIG. 29 is a schematic cross-sectional view of a battery case according to another modification; and

FIG. 30 is a perspective view of a battery case according to another modification.

### MODES FOR CARRYING OUT THE INVENTION

Hereinafter, embodiments of the present invention will be described with reference to the accompanying drawings.

### First Embodiment

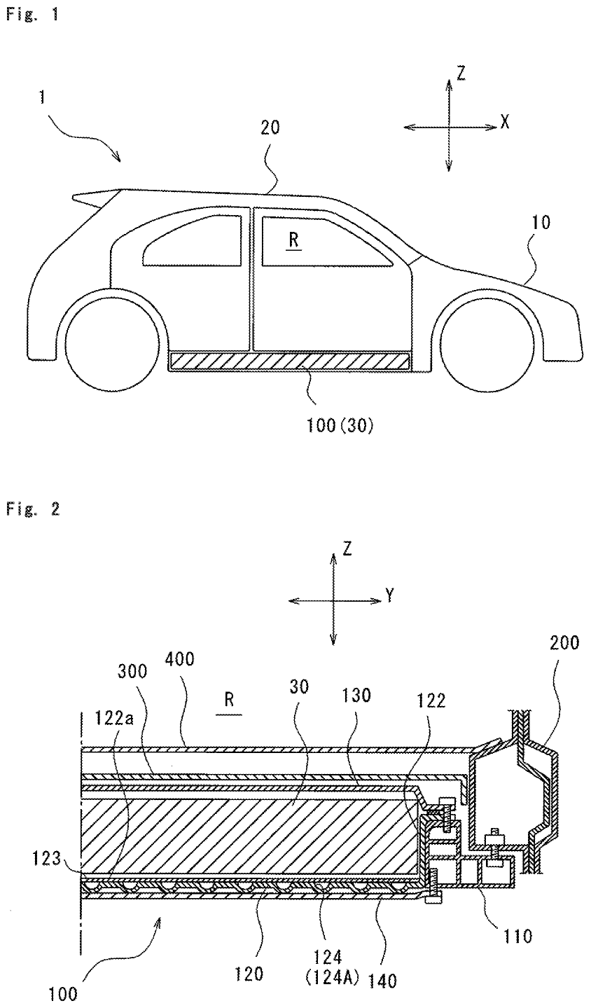

Referring to FIG. 1, an electric vehicle 1 is a vehicle that travels by driving a motor (not shown) by electric power supplied from a battery 30. For example, the electric vehicle 1 may be an electric car, a plug-in hybrid vehicle, or the like. The type of the vehicle is not particularly limited, and may be a passenger car, a truck, a maintenance vehicle, other mobility, or the like. Hereinafter, a case of a passenger car type electric vehicle as the electric vehicle 1 will be taken as an example to be described.

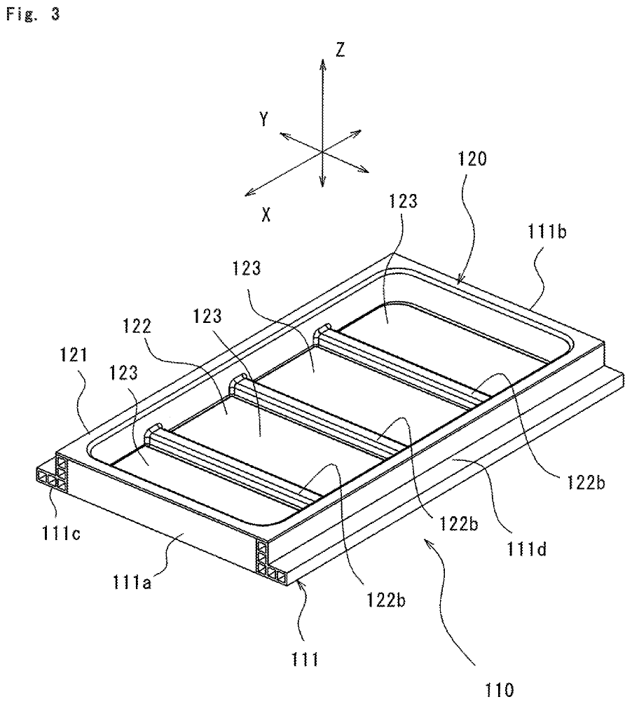

The electric vehicle 1 mounts a motor, a high-voltage apparatus, and the like (not shown) in the vehicle body front portion 10. In addition, the electric vehicle 1 mounts an electric vehicle battery case 100 (hereinafter, also simply referred to as a battery case 100) in which a battery 30 is stored in substantially the entire underfloor space of the vehicle interior R of the vehicle body central portion 20. It should be noted that in FIG. 1, the front-rear direction of the electric vehicle 1 is represented by the X direction, and the height direction is represented by the Z direction. The same notation also applies to the following drawings, and the vehicle width direction is represented by the Y direction in FIG. 2 and subsequent drawings.

Referring to FIG. 2, the battery case 100 is disposed inside the rocker member 200 in the vehicle width direction, and is supported by the rocker member 200. The rocker member 200 is a framework member extending in the vehicle front-rear direction at both lower ends in the vehicle width direction of the electric vehicle 1 (see FIG. 1). The rocker member 200 is formed by bonding a plurality of metal plates, and has a function of protecting the vehicle interior R and the battery case 100 against impact from the side of the electric vehicle 1.

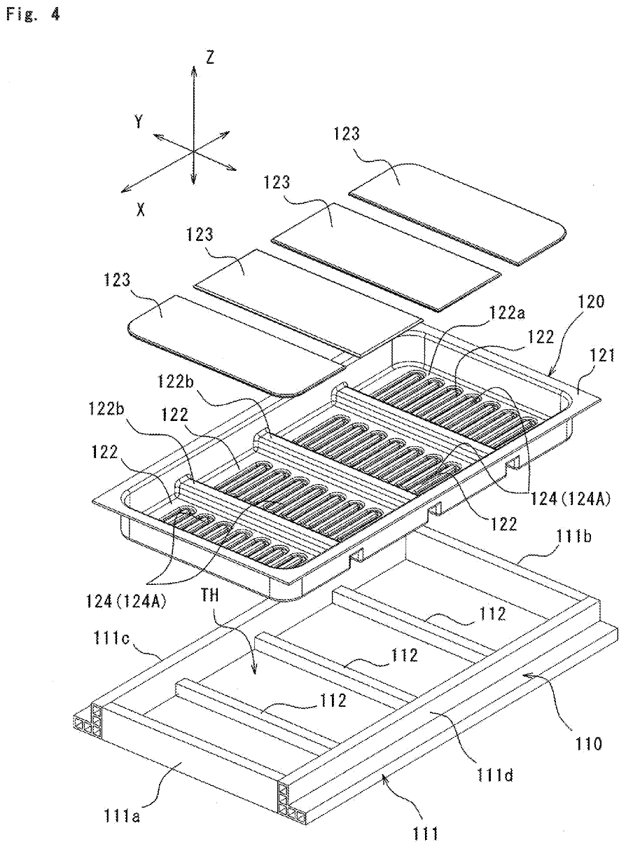

Referring also to FIGS. 3 and 4, the battery case 100 includes a frame 110 defining a through hole TH, a tray 120 having a bathtub shape, a top cover 130 (see FIG. 2) and an under cover 140 (see FIG. 2) arranged so as to sandwich them from above and below, and a closing plate 123 arranged on a bottom portion 122a of the tray 120. Here, the through hole TH is an example of a space in the present invention.

The frame 110 is a frame-shaped member forming the framework of the battery case 100, and is made of, for example, an aluminum alloy extruded product, an aluminum alloy cast product, a magnesium alloy extruded product, a magnesium alloy cast product, or a combination thereof. The frame 110 includes a frame-shaped body 111 having a rectangular shape in plan view, and three cross members 112 extending in the vehicle width direction in the frame-shaped body 111. In the present embodiment, the frame 110 having the through hole TH will be described as an example, but the shape of the frame 110 is not particularly limited. For example, the frame 110 may have a hollow portion having a recessed shape instead of the through hole TH. In this case, the hollow portion is an example of a space in the present invention.

The frame-shaped body 111 includes side walls 111c and 111d extending in the vehicle front-rear direction, and a front wall 111a and a rear wall 111b connecting the side walls and extending in the vehicle width direction. The side walls 111c and 111d are substantially L-shaped in a cross section perpendicular to the vehicle front-rear direction. The insides of the side walls 111c and 111d are partitioned into a plurality of chambers to be hollow-shaped. The front wall 111a and the rear wall 111b are quadrangular-tubular-shaped, and the insides of the front wall 111a and the rear wall 111b are also similarly hollow-shaped.

The three cross members 112 are provided at substantially equal intervals in parallel with the front wall 111a and the rear wall 111b, and connect the side wall 111c and the side wall 111d. The cross member 112 has a function of improving the strength of the battery case 100. In particular, the cross member 112 can improve strength against collision from the side of the electric vehicle 1 (see FIG. 1). The aspect of the cross member 112 is not particularly limited, and the shape, arrangement, number, and the like can be optionally set. In addition, the cross member 112 is not an essential configuration, and may be omitted as necessary.

The tray 120 is a bathtub-shaped member that houses the battery 30, and is made of, for example, an aluminum alloy or a magnesium alloy. The tray 120 includes a flange portion 121 extending in a horizontal direction (X, Y direction) at an outer edge portion, and a placement portion 122 being continuous with the flange portion 121 and having a recessed shape. The placement portion 122 is a portion on which the battery 30 is placed. As will be described below, the shape of the placement portion 122 is not limited to the recessed shape, and has only to be the one on which the battery 30 can be placed. For example, the placement portion 122 may have a flat shape.

A projecting portion 122b having a shape complementary to the cross member 112 is provided on the bottom portion 122a of the placement portion 122. The projecting portion 122b is a portion where the bottom portion 122a partially projects upward and extends in the vehicle width direction. In each bottom portion 122a of the placement portion 122 divided by the projecting portions 122b, a corresponding one of grooves 124 through which a coolant flows is formed.

The individual groove 124 is formed in a bellows shape in plan view. One end of the individual groove 124 is provided with an inlet 124a into which a coolant flows, and the other end is provided with an outlet 124b from which the coolant flows out. In particular, in the present embodiment, each of the inlet 124a and the outlet 124b is provided for the individual placement portion 122 divided by the projecting portions 122b.

From above each bottom portion 122a of the placement portions 122 divided by the projecting portions 122b, a corresponding one of the closing plates 123 having a corresponding shape is disposed and joined. Closing the groove 124 with the closing plate 123 defines a coolant flow path 124A through which a coolant flows.

A battery 30 (see FIG. 2) is disposed on the closing plate 123. The coolant flowing through the coolant flow path 124A cools the battery 30 via the closing plate 123. The closing plate 123 may be an aluminum plate or the like having high thermal conductivity in order to improve cooling efficiency.

A joining method such as an adhesive or thermal fusion (for example, laser thermal fusion) may be used when the closing plate 123 is joined to the tray 120. Preferably, friction stir welding (FSW) is used. Since the FSW is joining in a solid phase state, unlike normal welding, the FSW does not cause a blowhole and is excellent in sealing performance. In order to suitably achieve the joining by the FSW, the thickness of the closing plate 123 may be, for example, 2 mm or less (for example, about 1 mm).

In a state where the tray 120 and the frame 110 are combined (see FIG. 3), the flange portion 121 of the tray 120 is placed on the upper surface of the frame-shaped body 111 of the frame 110, and the placement portion 122 of the tray 120 is disposed in the frame-shaped body 111 of the frame 110. At this time, the projecting portion 122 b is disposed so as to partially cover the cross member 112. Although an exploded view is virtually shown in FIG. 4 for the sake of illustration, the tray 120 is integrated in a combined state as shown in FIG. 3 by being joined by press-fitting to the through hole TH of the frame 110. In this joining by press-fitting, the outer surface of the placement portion 122 of the tray 120 is in pressure contact with the inner surface of the frame-shaped body 111 of the frame 110, and the projecting portion 122b is in pressure contact with the cross member 112.

Referring to FIG. 2 again, the battery 30 is disposed on the placement portion 122 of the tray 120. Hermetically sealing the placement portion 122 with the top cover 130 from above the battery 30 stores the battery 30 in the battery case 100. The hermetic sealing structure prevents water from entering the battery case 100 from the outside. In addition, a safety valve for pressure adjustment inside the battery case 100 may be provided.

In the example in FIG. 2, the top cover 130 and the tray 120 are fastened and fixed to the frame 110 by screws. Above the top cover 130, a floor panel 300 constituting a floor surface of the vehicle interior R and a floor cross member 400 extending in the vehicle width direction in the vehicle interior R are disposed. In addition, an under cover 140 is disposed below the tray 120. The under cover 140 is screwed to the frame 110 and supports the tray 120 from below.

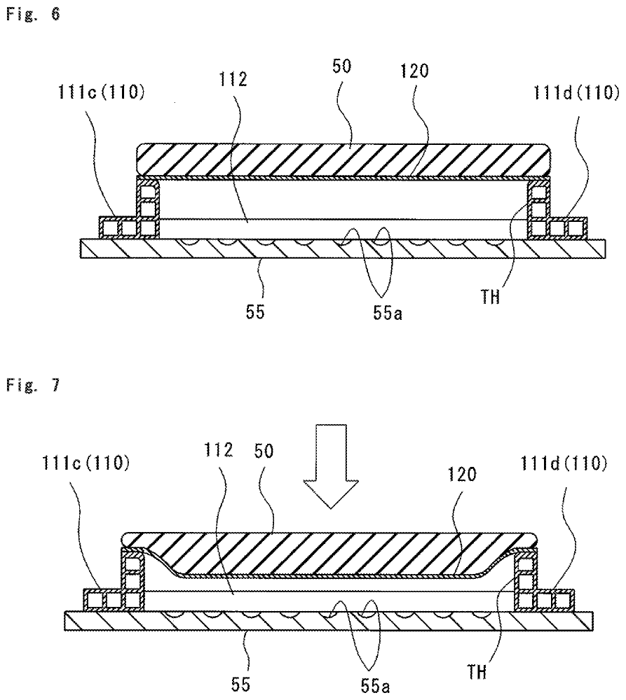

A method for manufacturing the battery case 100 having the above configuration will be described with reference to FIGS. 6 to 9.

Referring to FIG. 6, a frame 110 and a blank material 120 having a flat plate shape are prepared, and the frame 110 and the blank material 120 are superposed and disposed on a table 55. A recessed portion 55a having a shape corresponding to the groove 124 is formed on the upper surface of the table 55 in order to form the groove 124 in the tray 120 as described below. It should be noted that the same reference numeral 120 is used for the blank material and the tray, which means that the state before forming is the blank material and the state after forming is the tray.

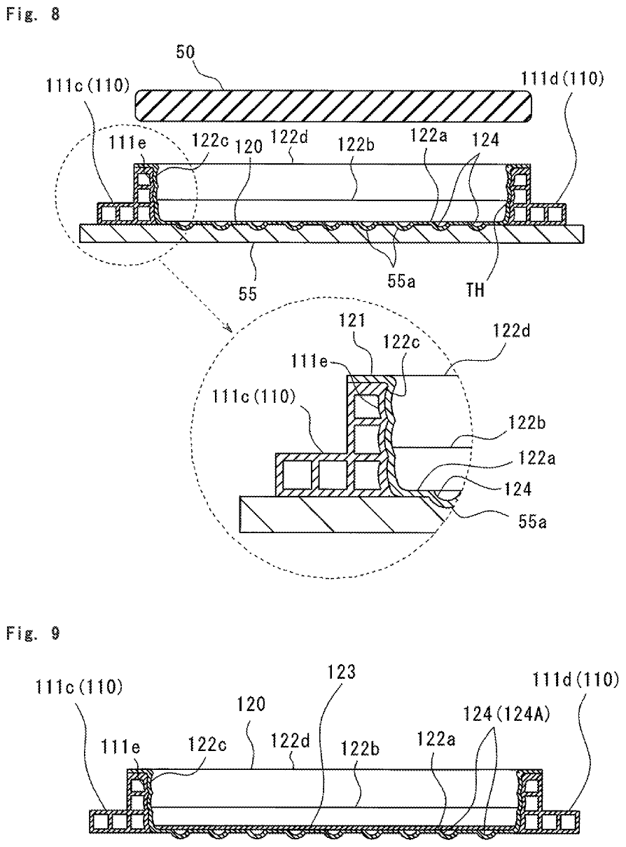

Next, referring to FIGS. 7 and 8, pressing the blank material 120 against the frame 110 causes the blank material 120 to swell into the through hole (space) TH of the frame 110. Thus, the blank material 120 is deformed into a tray 120 having a bathtub shape, and the blank material 120 (tray 120) is joined by press-fitting to the frame 110. As a result, the blank material 120 (tray 120) and the frame 110 are integrated.

In the present embodiment, the blank material 120 is pressurized by a pressure forming method. Here, the pressure forming method refers to a method of forming a member by gas or liquid pressure. In the present embodiment, in the pressure forming method, the hydraulic transfer elastic body 50 that is elastically deformable using the pressure of the liquid is used. Although not shown in detail, the hydraulic transfer elastic body 50 may have a structure in which only a lower surface of a metal chamber containing a liquid such as water or oil is closed with a rubber plate, for example. In such a hydraulic transfer elastic body 50, the rubber plate is elastically deformed by adjusting the pressure of the liquid, and forming can be performed without the liquid coming into direct contact with the blank material 120.

Referring to FIGS. 6 and 7, in the present embodiment, the frame 110, the blank material 120, and the hydraulic transfer elastic body 50 are superposed and disposed in this order on the table 55, and the blank material 120 is pressed against the frame 110 via the hydraulic transfer elastic body 50.

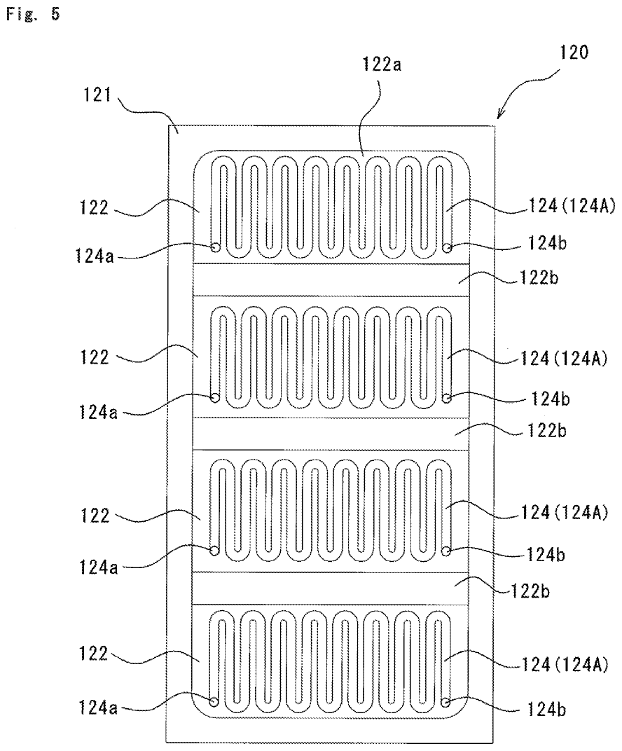

In addition, on the upper surface of the table 55, a recessed portion 55a having a shape corresponding to the groove 124 is formed so that the groove 124 can be formed in the tray 120 as described above. Therefore, a groove 124 (see FIG. 8) is formed in the bottom portion 122a of the tray 120 along with the pressurization by the hydraulic transfer elastic body 50. That is, in the present embodiment, the blank material 120 is formed into the tray 120 having a bathtub shape, and the groove 124 is formed in the bottom portion 122a of the placement portion 122 of the tray 120. A plan view shape of the groove 124 is not particularly limited, and may be, for example, a bellows shape as shown in FIG. 5. In addition, the cross-sectional shape of the groove 124 is not particularly limited either, and may be a semicircular shape as shown in FIGS. 8 and 9. In addition, although not shown in detail, in addition to the forming of the groove 124, a protrusion for positioning the battery 30 may be formed on the tray 120.

Referring to FIG. 8, when the pressurizing force is released after the blank material 120 is deformed into the bathtub-shaped tray 120, the hydraulic transfer elastic body 50 returns to a shape in the natural state. Therefore, the hydraulic transfer elastic body 50 can be easily removed from the inside of the tray 120. After the hydraulic transfer elastic body 50 is removed, the battery case 100 is formed by joining the top cover 130 and the under cover 140 as shown in FIG. 2.

In the present embodiment, in the frame 110, the front wall 11a, the rear wall 111b, and the side walls 111c and 111d have wall thicknesses of the upper portions set to be larger than those of the other portions. The upper portions of the front wall 111a, the rear wall 111b, and the side walls 111c and 111d are portions susceptible to force due to the forming described above, and the wall thicknesses of the portions are increased to prevent unintended deformation. In addition, an R shape (round shape) is imparted to inner upper portions of the front wall 111a, the rear wall 111b, and the side walls 111c and 111d. The R-shape (round shape) promotes the inflow of the material into the inside of the blank material 120 in the forming. However, in view of the design of the extrusion material or the like, a small corner R (fillet R) may be provided in addition to the inner upper portion of the frame 110. In the drawing, such a small corner R is omitted.

In the present embodiment, with reference to FIG. 8, when the blank material 120 is formed into the bathtub-shaped tray 120, negative angle forming is performed to form a negative angle at least partially from the bottom portion 122a of the tray 120 toward the opening portion 122d in the upper part. Here, the negative angle is a term often used in the forming field using a die, and indicates that the die draft angle in the formed member is less than zero (negative). In the present embodiment, the frame 110 having no negative angle portion in advance and the blank material 120 are integrally deformed by pressurization from the hydraulic transfer elastic body 50 to form a negative angle, whereby negative angle forming is performed. In the illustrated example, the inner surface of the frame 110 is deformed outward for each chamber, and the blank material 120 is also deformed outward along the deformation, so that the negative angle portions 111e and 122c are formed. In FIG. 8, a region surrounded by a broken line circle is enlarged to be shown in order to show the negative angle portions 111e and 122c more clearly.

Next, referring to FIG. 9, the closing plate 123 is disposed and joined to the bottom portion 122a of the tray 120 so as to close the groove 124 formed as described above. The closing plate 123 is disposed on the placement portion 122 of the tray 120 from above, and is joined by, for example, an FSW. In this manner, the closing plate 123 and the groove 124 define a coolant flow path 124A through which a coolant flows.

According to the battery case 100 and the method for manufacturing the same as described above, the following actions and effects are produced.

Since the coolant flow path 124A is formed in the bottom portion 122a of the placement portion 122 of the tray 120, the battery 30 placed on the placement portion 122 can be efficiently cooled. In addition, since the coolant flow path 124A is formed in the bottom portion of the battery case 100 itself, it is not necessary to configure a cooler as a separate component. That is, since the battery case and the cooler can be integrated, space efficiency can be improved. In addition, since the placement portion 122 of the tray 120 is hermetically sealed by the top cover 130, high sealing performance capable of preventing water from entering from a road surface or the like can be secured.

Since the coolant flow path 124A is individually provided for the battery 30 placed on each of the divided placement portions 122, the cooling amount of the individual battery 30 can be made uniform.

Since the placement portion 122 on which the battery 30 is placed is formed in a recessed shape, the battery 30 can be housed in the placement portion 122. In addition, since both the placement portion 122 and the groove 124 are to be formed in a recessed shape, the placement portion 122 and the groove 124 can be formed by pressure forming as in the present embodiment.

The pressure forming method makes it possible to omit the draft angle (inclination of the side surface), which is difficult in normal cold press forming, and to reduce the roundness of the ridgeline portion or the corner portion, and to be formed into a tray 120 having any shape. As described above, omitting the draft angle and reducing the roundness of the ridgeline portion allows the space efficiency of the battery case 100 to be improved and the battery 30 having a larger capacity to be mounted.

Since the hydraulic transfer elastic body 50 is used in the pressure forming method, the liquid to which pressure is applied does not scatter or leak when the blank material 120 is formed. If the hydraulic transfer elastic body 50 is not used in the pressure forming method, since the blank material 120 is directly deformed by a fluid held at a high pressure, it is necessary to strongly constrain the outer edge portion of the blank material 120 so that the fluid does not scatter or leak to the outside. However, when the hydraulic transfer elastic body 50 is used, since the liquid to which the force is applied does not scatter or leak, the constraint force on the outer edge portion of the blank material 120 can be reduced. Therefore, when the blank material 120 is formed into a bathtub shape, the material amount flowing from the outer edge portion to the inside can be increased, and stable machining can be achieved by suppressing cracking or the like of the blank material 120. In addition, since it is not necessary to completely seal the outer edge portion of the blank material 120, maintenance of the die and the pressing machine for constraining the outer edge portion becomes easy, and productivity can be improved.

In the present embodiment, by the pressure forming method, the blank material 120 is formed into the tray 120 and is integrated with the frame 110 at the same time. At this time, since the blank material 120 having a flat plate shape is formed into the tray 120 having a bathtub shape, there is no seam, and high sealing performance can be secured. In addition, since the blank material 120 is formed into the tray 120 and joined to the frame 110 at the same time, the joining step can be simplified. Since the blank material 120 is joined by press-fitting to the frame 110 instead of welding, it is possible to achieve highly accurate joining without causing thermal deformation.

Since the negative angle is formed in the tray 120, it is possible to prevent the joining by press-fitting with the frame 110 from being released by the negative angle portion. Therefore, the joining strength between the frame 110 and the tray 120 is increased by the negative angle forming. In particular, the negative angle forming is effective forming for a pressure forming method because in cold press forming requiring a draft angle using a normal die, there is a problem that a cam mechanism needs to be added and a die structure becomes complicated.

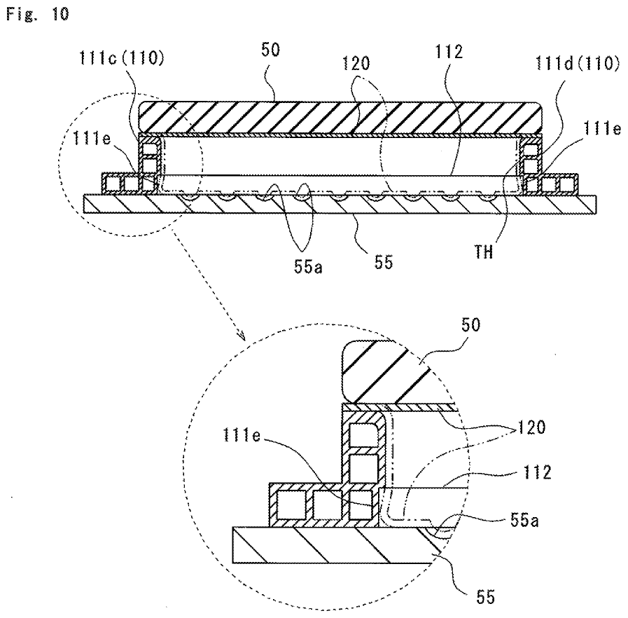

In the present embodiment, since the blank material 120 and the frame 110 having had no negative angle portion in advance are integrally deformed to form a negative angle, it is not necessary to provide the negative angle portion 111e in advance to the frame 110 as shown in FIGS. 10 to 12 described below. Therefore, negative angle forming can be easily performed.

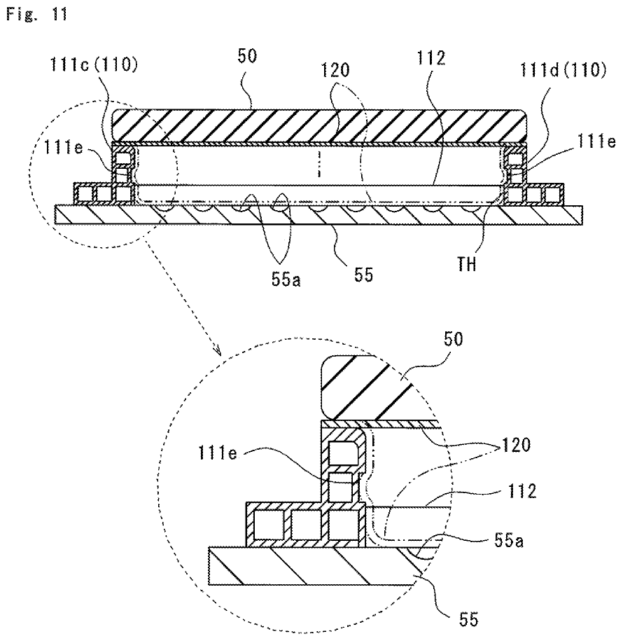

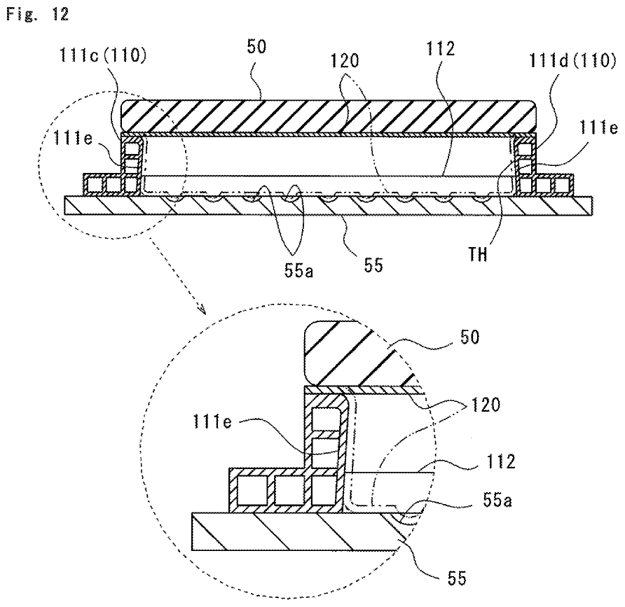

As a modification of the negative angle forming, the negative angle portion 110e may be provided in the frame 110 in advance as shown in FIGS. 10 to 12. In this case, the negative angle forming is performed by pressing the blank material 120 against the negative angle portion 111e of the frame 110. In the example in FIG. 10, a negative angle portion 111e is formed as a recess on a lower inner surface in the vehicle height direction of the frame 110. In the example in FIG. 11, a negative angle portion 111e is formed as a recess on the inner surface of the central portion in the vehicle height direction of the frame 110. In the example in FIG. 12, the inner surface of the frame 110 is inclined toward the center of the frame 110, thereby forming the negative angle portion 111e as an inclined surface. In addition, the negative angle portion 111e may also be formed in the cross member 112. Thus, by providing the negative angle portion 111e in the frame 110 in advance, the negative angle forming can be easily and reliably performed.

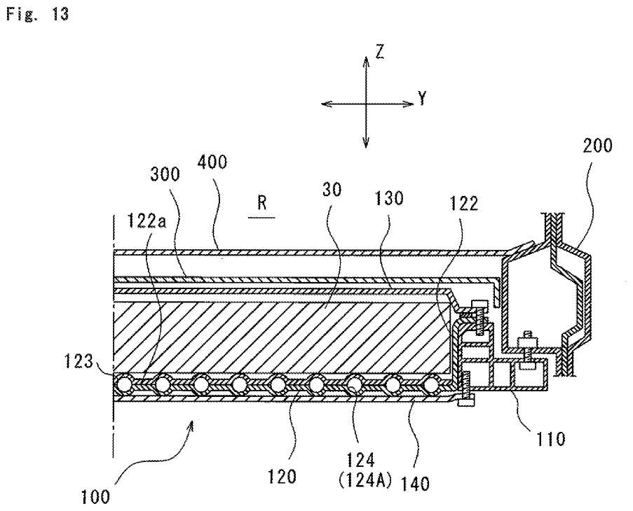

In addition, as a modification of the closing plate 123, an uneven shape may be imparted to the closing plate 123 as shown in FIG. 13. In the configuration described above, the closing plate 123 having a flat surface is exemplified, but an upward protruding shape (downward recessed shape) may be imparted to the closing plate 123 in accordance with the shape of the groove 124 so as to enlarge the flow path area of the coolant flow path 124A. In the example in FIG. 13, a semicircular shape vertically symmetrical with respect to the semicircular shape of the groove 124 is imparted to the closing plate 123. In this way, by enlarging the flow path area of the coolant flow path 124A, the flow rate of the coolant can be increased, and the cooling performance can be improved.

### Second Embodiment

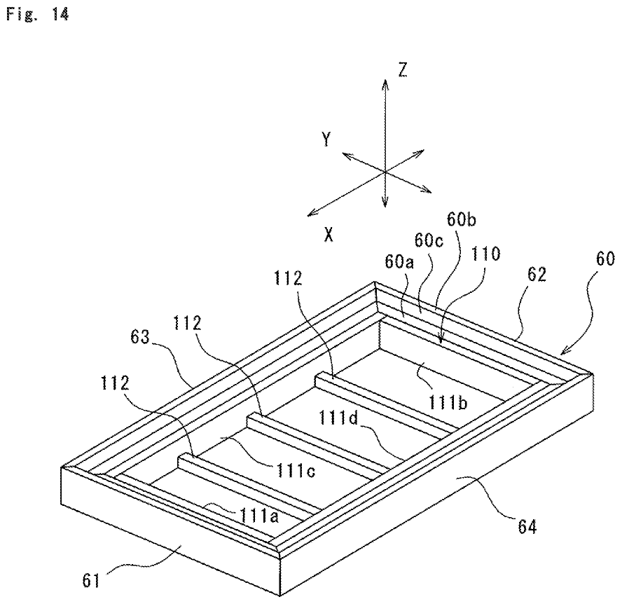

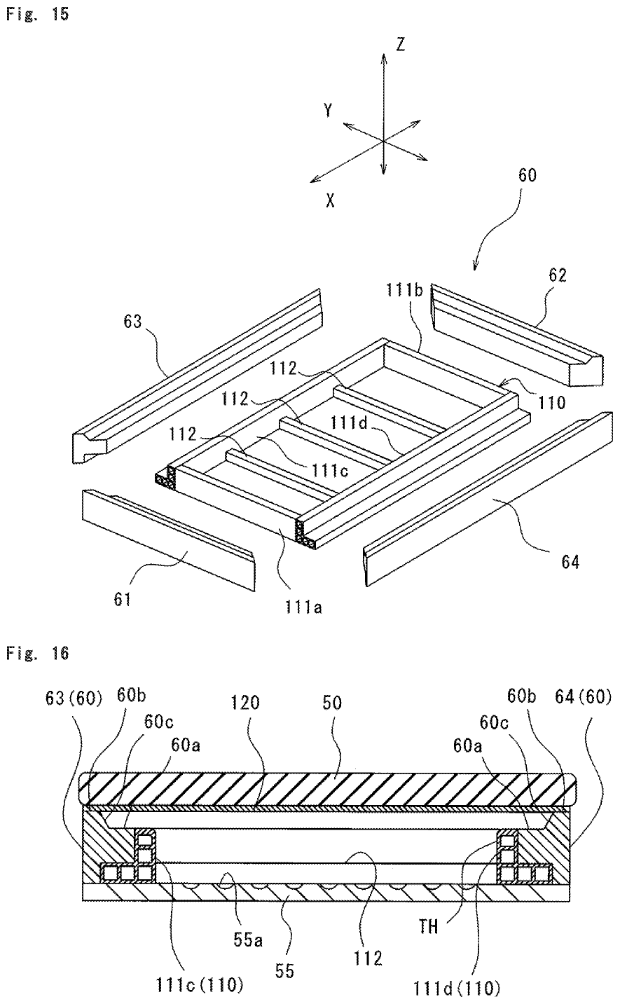

Referring to FIGS. 14 and 15, in the second embodiment, a constraining die 60 that constrains the movement of the frame 110 is used. The configuration of the battery case 100 of the present embodiment is substantially the same as that of the first embodiment. The method for manufacturing the battery case 100 of the present embodiment is also substantially the same as that of the first embodiment except for relating to the use of the constraining die 60. Therefore, description of the same portions as of the first embodiment may be omitted.

The constraining die 60 has a shape complementary to that of the frame 110 and is disposed outside the frame 110 in plan view. The constraining die 60 includes a front constraining member 61 and a rear constraining member 62 that respectively support the front wall 111a and the rear wall 111b, and side constraining members 63 and 64 that respectively support the side walls 111c and 111d. The front constraining member 61, the rear constraining member 62, and the side constraining members 63 and 64 are combined to form a frame shape in plan view. The upper surface of the constraining die 60 has a two-step shape. Specifically, the upper surface of the constraining die 60 has a first surface 60a aligned at substantially the same height as the upper surface of the frame 110 and a second surface 60b provided one step higher than the upper surface of the frame 110. The first surface 60a and the second surface 60b are connected by an inclined surface 60c, and the second surface 60b is disposed outside the first surface 60a in plan view. In addition, the lower surfaces of the frame 110 and the constraining die 60 are aligned. Therefore, when the height dimensions of the frame 110 and the constraining die 60 are compared, the height of the constraining die 60 is set larger than the height of the frame 110.

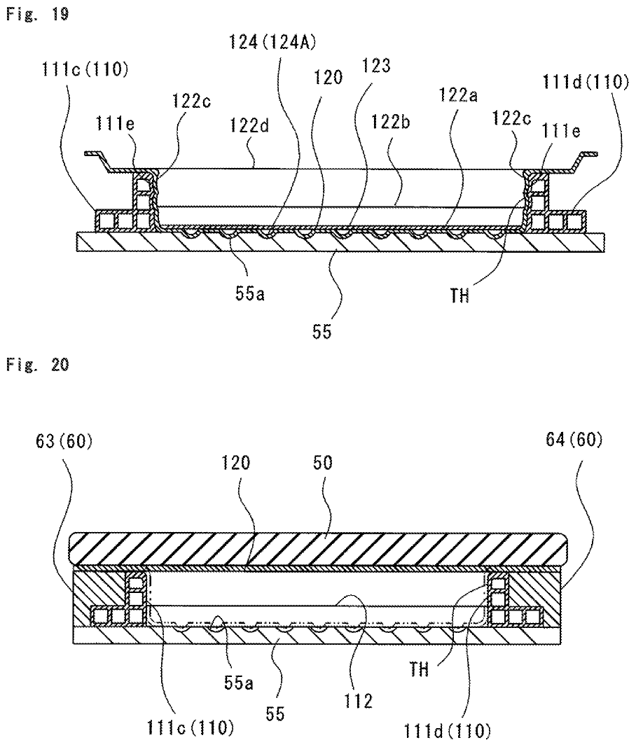

In the method for manufacturing the battery case 100 of the present embodiment, in addition to the first embodiment, the constraining die 60 that constrains the movement of the frame 110 is further prepared, and the constraining die 60 is fixed and disposed outside the frame 110 in plan view (see FIGS. 14 and 15). Thereafter, as shown in FIGS. 16 to 18, the blank material 120 is deformed into a bathtub-shaped tray 120 and integrated with the frame 110 in the same manner as described above. At this time, simultaneously, the groove 124 is formed in the bottom portion 122a of the placement portion 122 of the tray 120. Then, as shown in FIG. 19, the closing plate 123 is disposed and joined to the tray 120.

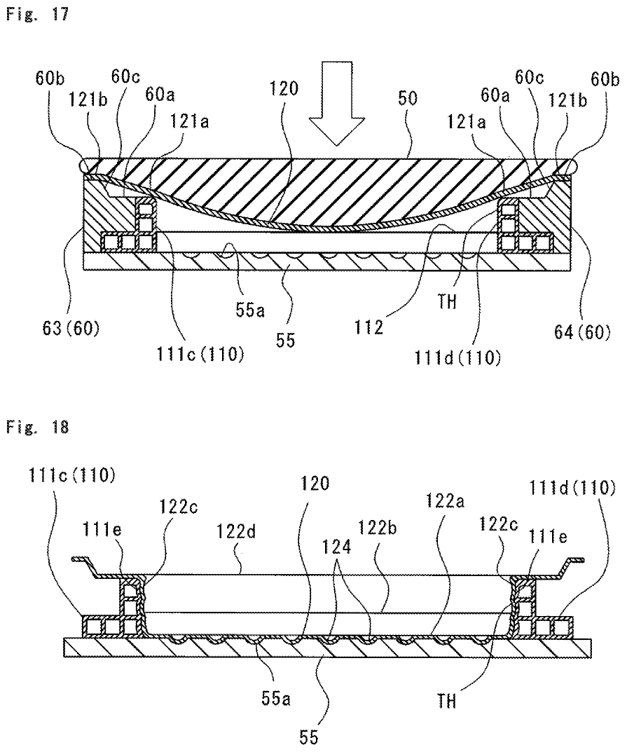

Specifically, as shown in FIG. 16, the blank material 120 is disposed on the constraining die 60, and as shown in FIG. 17, the blank material 120 is pressurized via the hydraulic transfer elastic body 50, whereby the first outer edge portion 121a of the blank material 120 is supported by the frame 110, and the second outer edge portion 121b (outermost edge portion) on the outer side of the first outer edge portion 121a (portion slightly inside the outermost edge portion) is supported by the second surface 60b of the constraining die 60. Thus, the blank material 120 is disposed so as to be bent so that the height decreases from the outside toward the inside, and the blank material 120 is continuously pressurized from the state in which the blank material 120 is bent in this manner, whereby the blank material 120 is deformed into the tray 120 having a bathtub shape in which the groove 124 is formed in the bottom portion 122a, and is joined by press-fitting to the frame 110 (see FIG. 18).

After the joining by press-fitting, as shown in FIG. 19, the closing plate 123 is disposed and joined to the bottom portion 122a of the tray 120 so as to close the groove 124. The closing plate 123 is disposed on the bottom portion 122a of the placement portion 122 of the tray 120 from above, and is joined by, for example, an FSW. In this manner, the closing plate 123 and the groove 124 define a coolant flow path 124A.

According to the present embodiment, since the blank material 120 is pressurized in a state where the blank material 120 is bent so that the height decreases from the outside toward the inside, the amount of the material flowing into the inside of the blank material 120 can be increased, and the roundness of the ridge line portion or the corner portion of the bottom portion 122a of the tray 120 can be further reduced.

Alternatively, as shown in FIG. 20, height dimensions of the frame 110 and the constraining die 60 may be the same. In the example in FIGS. 14 to 19, the amount of material flowing into the inside of the blank material 120 is increased by making the height dimension of the constraining die 60 larger than that of the frame 110. However, when there is no problem in forming the tray 120, as shown in FIG. 20, the upper surface of the frame 110 and the upper surface of the constraining die 60 may be aligned for the purpose of improving the material yield.

### Third Embodiment

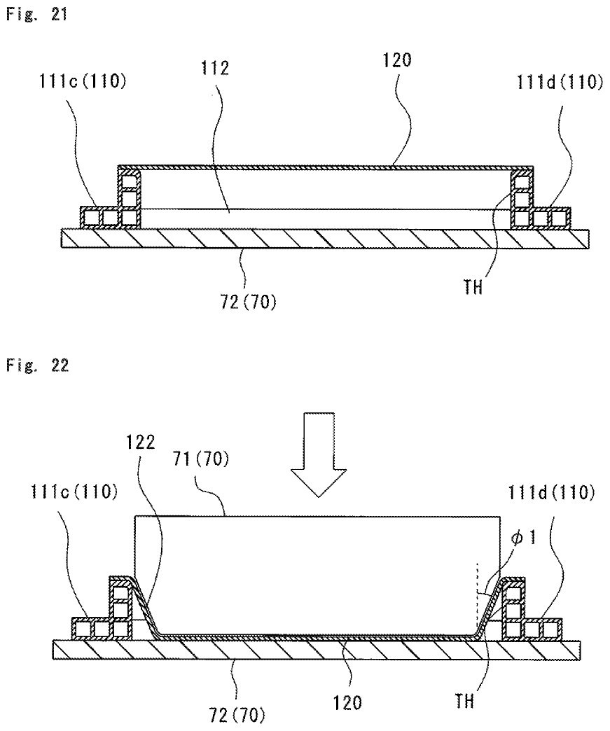

Referring to FIGS. 21 to 24, in the third embodiment, cold press forming using a die 70 is performed instead of pressure forming by the hydraulic transfer elastic body 50 (see FIGS. 6 to 8) of the first embodiment. In the cold press forming, the above-described negative angle forming is not performed, and a constant draft angle is set in the die 70 as described below. The configuration of the battery case 100 of the present embodiment is substantially the same as that of the first embodiment except for relating to not having a negative angle portion. The method for manufacturing the battery case 100 of the present embodiment is substantially the same as that of the first embodiment except for relating to the above-described die 70. Therefore, description of the same portions as of the first embodiment may be omitted.

The die 70 includes a first punch 71 and a first die 72 that perform first cold press forming, and a second punch 73 and a second die 74 that perform second cold press forming.

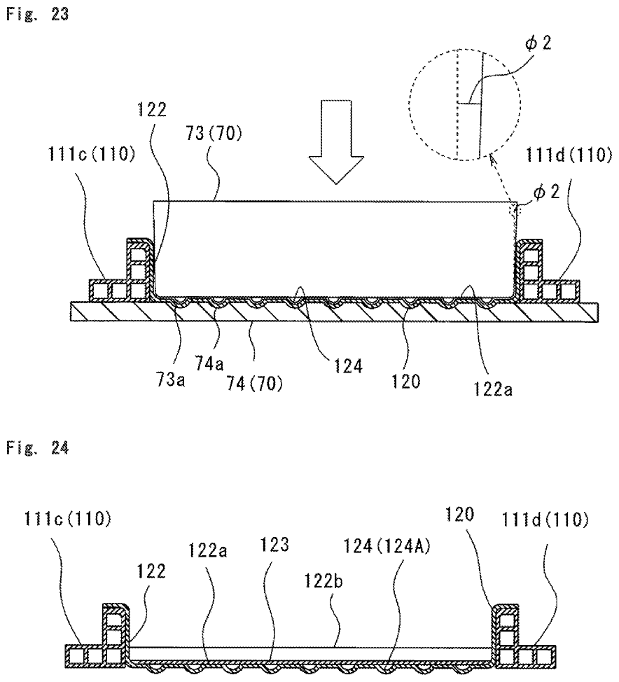

As shown in FIGS. 21 and 22, in the first cold press forming, primary forming is performed so that the blank material 120 is sandwiched between the first punch 71 vertically driven and the fixed first die 72. The first punch 71 is provided with a predetermined first draft angle φ1. Therefore, the first punch 71 is driven downward to press form the blank material 120, and then is driven upward to be separable from the blank material 120. In addition, the upper surface of the first die 72 is flat. Therefore, in the first cold press forming, the groove 124 (see FIG. 23) is not formed. In the first cold press forming, a recessed shape serving as the placement portion 122 of the tray 120 is formed. It should be noted that in the first cold press forming, the frame 110 and the tray 120 are not completely joined by press-fitting, and are not integrated.

Subsequently, as shown in FIG. 23, in the second cold press forming, secondary forming is performed so that the blank material 120 is sandwiched between the second punch 73 vertically driven and the fixed second die 74. The second punch 73 is provided with a predetermined second draft angle φ2 smaller than the first draft angle φ1. Therefore, the second punch 73 is driven downward to press form the blank material 120, and then is driven upward to be separable from the blank material 120. It should be noted that in FIG. 23, a region surrounded by a broken line circle is enlarged to be shown in order to clearly illustrate the second draft angle φ2. In addition, the lower surface of the second punch 73 has a protruding portion 73a having a shape complementary to the groove 124 so as to form the groove 124 in the bottom portion 122a of the placement portion 122 of the tray 120. The upper surface of the second die 74 has a recessed portion 74a having a shape corresponding to the groove 124 so as to form the groove 124 in the tray 120.

In the present embodiment, as described above, the recessed-shaped placement portion 122 is schematically formed in the blank material 120 by the first cold press forming, and the shape of the placement portion 122 is adjusted and the groove 124 is formed in the bottom portion 122a of the placement portion 122 by the second cold press forming. In addition, in the second cold press forming, the frame 110 and the tray 120 are joined by press-fitting to be integrated.

According to the present embodiment, the tray 120 is formed by two-stage cold press forming of first and second cold press forming. In the cold press forming, although depending on the machinability of the material, it is difficult to simultaneously form a large recessed shape such as the placement portion 122 and a small recessed shape such as the groove 124 with high machining accuracy. Thus, by performing these pieces of forming in two stages, forming with different machining accuracy can be stably achieved.

Preferably, softening heat treatment may be performed on the blank material 120 between the first cold press forming and the second cold press forming. By the softening heat treatment, it is possible to remove the machining distortion of the blank material 120 that may be caused by the first cold press forming. Accordingly, since the elongation of the material is recovered, the roundness of the ridgeline portion or the corner portion of the tray 120 can be further reduced in the second cold press forming.

In addition, the pressure forming of the first embodiment and the cold press forming of the present embodiment may be used in combination. Specifically, cold press forming may be executed to schematically form the placement portion 122 in the blank material 120 without changing the step corresponding to the first cold press forming of the present embodiment, the step corresponding to the second cold press forming may be changed to pressure forming, and the shape of the placement portion 122 may be adjusted by a pressure forming method and the groove 124 may be formed in the bottom portion 122a of the placement portion 122 by the pressure forming method. Thus, a large recessed shape such as the placement portion 122 can be easily formed by cold press forming, and a small recessed shape such as the groove 124 can be accurately formed by pressure forming method. Therefore, stable forming of the blank material 120 can be achieved.

### Fourth Embodiment

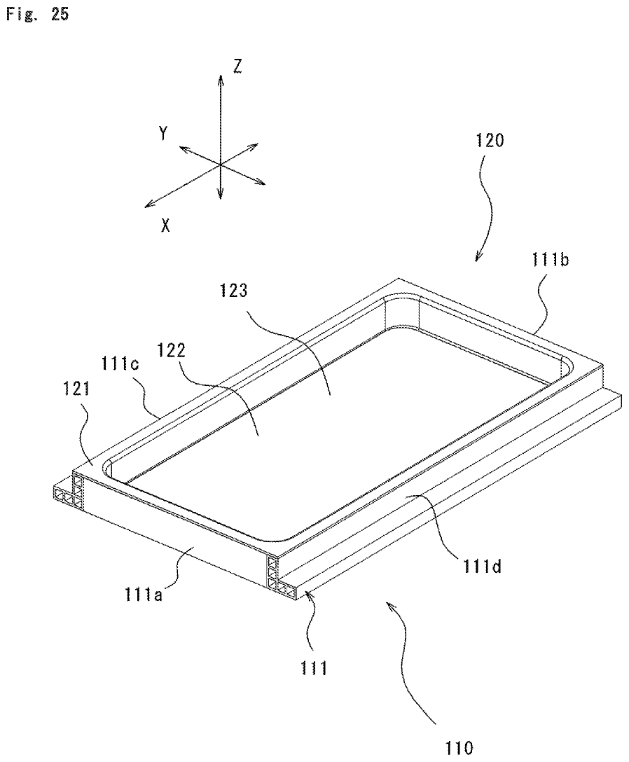

Unlike the first embodiment, a battery case 100 of a fourth embodiment shown in FIGS. 25 to 27 is not provided with a cross member 112 (see FIG. 4). Along with this, shapes of the frame 110, the tray 120, and the like are different from those of the first embodiment. Except for relating to this, the configuration of the battery case 100 of the present embodiment and the method for manufacturing the same are substantially the same as those of the first embodiment. Therefore, description of the same portions as shown in the first embodiment may be omitted.

In the present embodiment, the frame 110 does not include a cross member 112 (see FIG. 4). Along with this, the tray 120 also does not include the projecting portion 122b (see FIG. 4). Therefore, the placement portion 122 is not divided, and the tray 120 has one large placement portion 122. Therefore, only one closing plate 123 is provided corresponding to the placement portion 122.

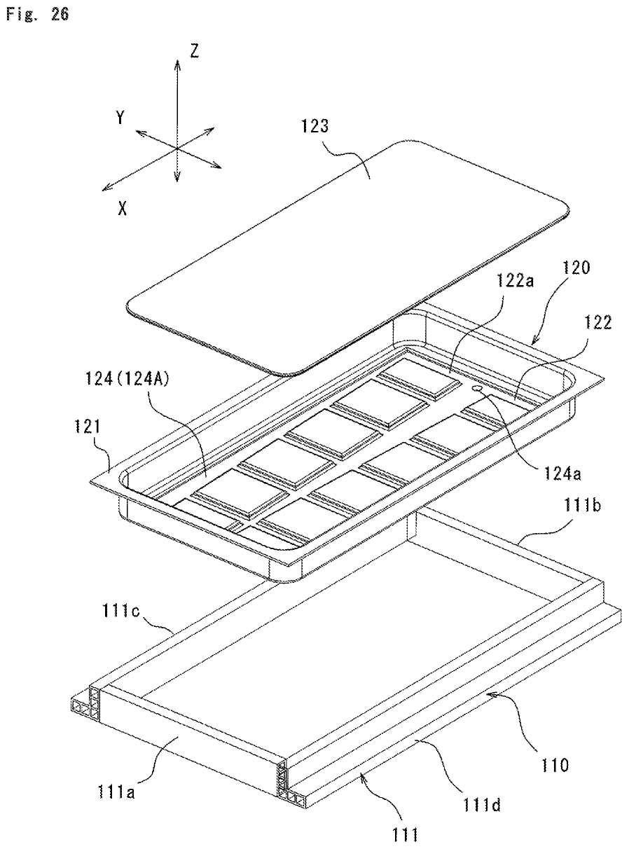

Referring to FIG. 26, in the present embodiment, the groove 124 constituting the coolant flow path 124A has a constant depth. Therefore, the flow path area of the coolant flow path 124A depends on the width of the groove 124 in plan view. Although an exploded view is virtually shown in FIG. 26 for the sake of illustration, the tray 120 is integrated in a combined state as shown in FIG. 25 by being joined by press-fitting to the through hole TH of the frame 110.

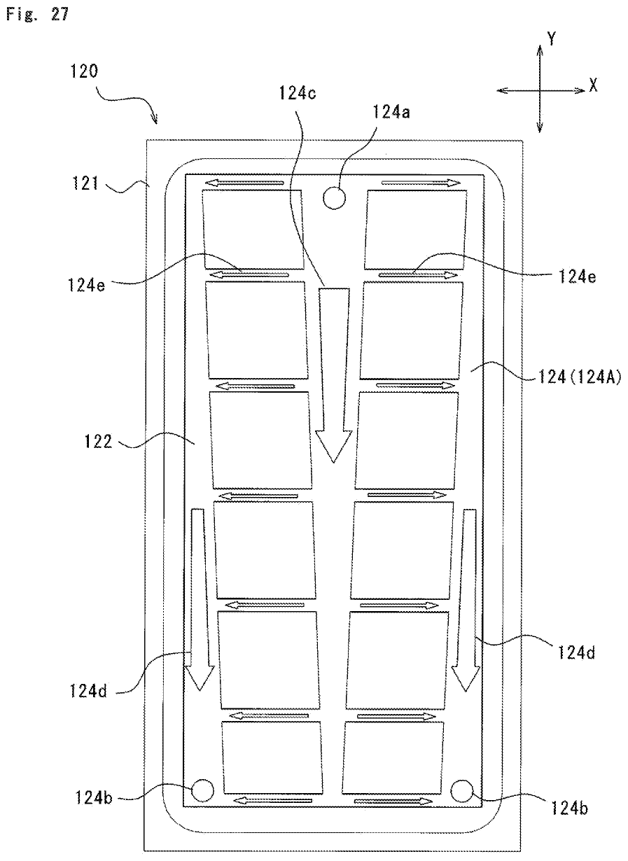

Referring to FIG. 27, the coolant flow path 124A includes an inlet 124a, an outlet 124b, an inflow path 124c extending from the inlet 124a, an outflow path 124d extending to the outlet 124b, and a branch path 124e branching from the inflow path 124c and joining at the outflow path 124d. The inflow path 124c has a flow path area larger than that of the branch path 124e. The outflow path 124d has a flow path area larger than that of the branch path 124e. It should be noted that thick arrows in FIG. 27 indicate the flows of the coolant.

In the present embodiment, in the vehicle front-rear direction, an inlet 120a being one circular hole is provided at one end portion of the tray 120, and outlets 124b being two circular holes are provided at the other end portions of the tray 120. In the vehicle width direction, the inlet 124a is provided at a central portion, and the outlets 124b are provided at both end portions. Pipes (not shown) are connected to the inlet 124a and the outlets 124b, and a coolant flows in and out through the pipes.

The inflow path 124c extends from one end portion to the other end portion in the vehicle front-rear direction at the center in the vehicle width direction. The flow path area of the inflow path decreases from the inlet 124a toward the outlets 124b. The outflow paths 124d extend from one end portion to the other end portion at both end portions in the vehicle width direction. The flow path area of the outflow path 124d increases from the inlet 124a toward the outlets 124b. The branch path 124e extends in the vehicle width direction so as to connect the inflow path 124c and the outflow path 124d, and a plurality of branch paths are provided at equal intervals in the vehicle front-rear direction.

According to the present embodiment, since the shape of the coolant flow path 124A is suitably designed as described above, the flow of the coolant in the coolant flow path 124A can be made uniform. The coolant flows through the inlet 124a, the inflow path 124c, the branch path 124e, the outflow path 124d, and the outlet 124b in this order. Since the branch path 124e branches from the inflow path 124c, the inflow path 124c has a flow path area larger than that of the branch path 124e, thereby reducing a flow rate change due to the branching. In addition, since the branch path 124e joins the outflow path 124d, the outflow path 124d has a larger flow path area than the branch path 124e, thereby reducing a flow rate change due to the joining.

In addition, in the coolant flow path 124A, the flow rate of the inflow path 124c decreases every time the branch path 124e branches from the inflow path 124c. Therefore, reducing the flow path area of the inflow path 124c from the inlet 124a toward the outlet 124b in accordance with the flow rate reduction due to the branching makes the flow of the coolant uniform. In addition, in the coolant flow path 124A, the flow rate of the outflow path 124d increases every time the branch path 124e joins the outflow path 124d. Therefore, increasing the flow path area of the outflow path 124d from the inlet 124a toward the outlet 124b in accordance with the flow rate increase due to the joining makes the flow of the coolant uniform.

As described above, although the specific embodiments and their modifications of the present invention are described, the present invention is not limited to the above-described embodiments, and can be implemented with various modifications within the scope of the present invention. For example, an appropriate combination of contents of the individual embodiments may be one embodiment of the present invention.

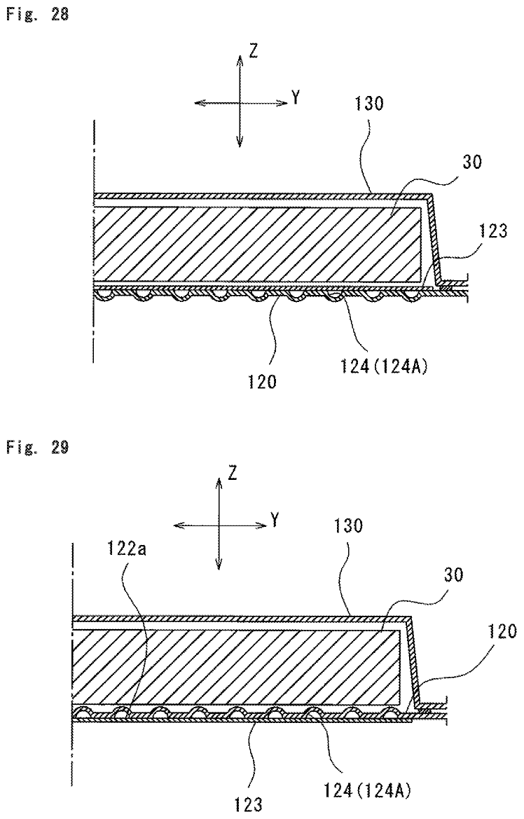

In addition, referring to FIG. 28, the configuration of the placement portion 122 for placing the battery 30 is not limited to that of the above embodiments. For example, the placement portion 122 does not need to have a recessed shape for housing the battery 30 as shown in FIGS. 3 and 25, and may be substantially flat. In this case, the top cover 130 has a recessed shape, and the top cover 130 closes the placement portion 122, whereby the battery 30 is housed.

In addition, referring to FIG. 29, the configuration of the coolant flow path 124A is not limited to that of the above embodiments. For example, the closing plate 123 has only to have a mode of closing the groove 124 in the bottom portion 122a of the tray 120, and does not need to be disposed and joined from above. In other words, the closing plate 123 may be disposed and joined so as to close the groove 124 from below. In this case, the groove 124 formed in the bottom portion 122a of the tray 120 is formed vertically opposite to that of the above embodiments. That is, in this case, the groove 124 is formed in a downward recessed shape (upward protruding shape).

In addition, the materials of the respective members constituting the battery case 100 are not limited to those exemplified in the above embodiments. For example, the frame 110 may be made of high-tension steel, and the tray 120 may be made of an aluminum alloy. Alternatively, for example, the frame 110 may be made of an aluminum alloy, and the tray 120 may be made of a coated steel plate such as a laminated steel plate. Further alternatively, for example, the frame 110 may be an aluminum alloy extruded product, and the tray 120 may be made of resin.

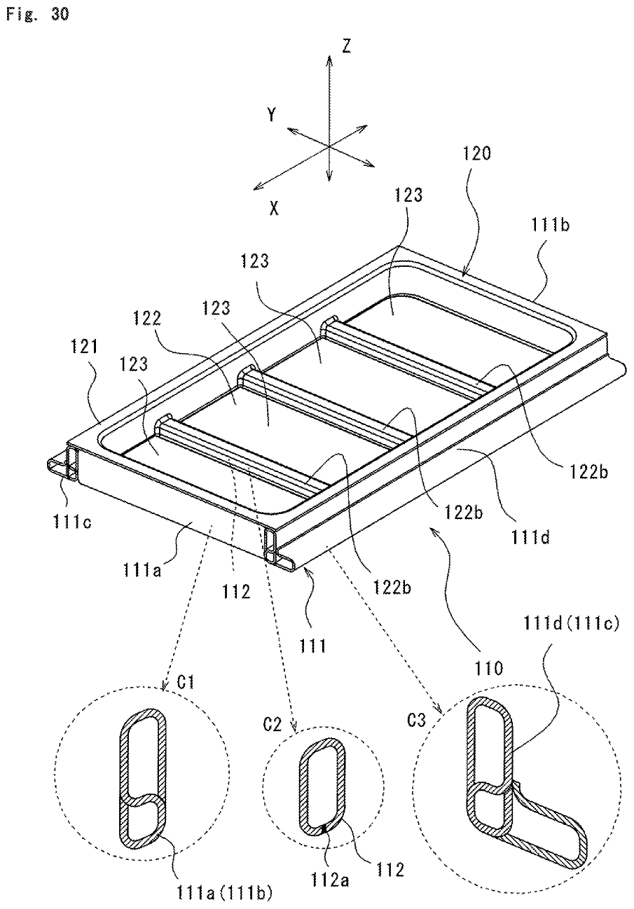

In addition, referring to FIG. 30, the frame 110 may be made of a steel plate roll form. Specifically, ultra-high-tensile steel plates such as MS steel may be machined by roll forming to form the frame-shaped body 111 (front wall 111a, rear wall 111b, side walls 111c and 111d) and cross members 112 of the frame 110. In FIG. 30, broken line circles C1 to C3 respectively show the cross-sectional shapes of the front wall 111a (the same applies to the rear wall 111b), the cross member 112, and the side wall 111d (the same applies to the side wall 111c). In the broken line circle C1, the front wall 111a (the same applies to rear wall 111b) is formed in an 8-shape from one steel plate. In the broken line circle C2, the cross member 112 is formed in a 0 shape from one steel plate, and a closed cross-section is formed by laser welding particularly at the welding point 112a. In the broken line circle C3, an 8-shaped steel plate and a C-shaped steel plate are combined to form a side wall 111d (the same applies to the side wall 111c).

### DESCRIPTION OF SYMBOLS

1 Electric vehicle
10 Vehicle body front portion
20 Vehicle body central portion
30 Battery
50 Hydraulic transfer elastic body
55 Table
55a Recessed portion
60 Constraining die
60a First surface
60b Second surface
60c Inclined surface
61 Front constraining member
62 Rear constraining member
63, 64 Side constraining member
70 Die
71 First punch
72 First die
73 Second punch
73a Protruding portion
74 Second die
74a Recessed portion
100 Battery case (electric vehicle battery case)
110 Frame
111 Frame-shaped body
111a Front wall
111b Rear wall
111c, 111d Side wall
111e Negative angle portion
112 Cross member
112a Welding point
120 Tray (blank material)
121 Flange portion
121a First outer edge portion
121b Second outer edge portion
122 Placement portion
122a Bottom portion
122b Projecting portion
122c Negative angle portion
122d Opening portion
123 Closing plate
124 Groove
124A Coolant flow path
124a Inlet
124b Outlet
124c Inflow path
124d Outflow path
124e Branch path
130 Top cover
140 Under cover
200 Rocker member
300 Floor panel
400 Floor cross member

1. An electric vehicle battery case comprising:
a tray including a placement portion on which a battery is placed and having a groove formed in a bottom portion of the placement portion;
a closing plate joined to the tray to close the groove and define a coolant flow path; and
a top cover configured to seal the placement portion of the tray.

2. The electric vehicle battery case according to claim 1,
wherein the coolant flow path includes an inlet, an outlet, an inflow path extending from the inlet, an outflow path extending to the outlet, and a branch path branching from the inflow path and joining at the outflow path,
wherein the inflow path has a larger flow path area than the branch path, and
wherein the outflow path has a larger flow path area than the branch path.

3. The electric vehicle battery case according to claim 2,
wherein the flow path area of the inflow path decreases from the inlet toward the outlet, and
wherein the flow path area of the outflow path increases from the inlet toward the outlet.

4. The electric vehicle battery case according to claim 1,
wherein the placement portion is divided by a projecting portion having a bottom surface partially projecting upward and extending in a vehicle width direction, and
wherein each obtained by dividing the placement portion is provided with an inlet and an outlet of the coolant flow path.

5. A method for manufacturing an electric vehicle battery case, the method comprising:
preparing a tray including a placement portion on which a battery is placed and having a groove formed in a bottom portion of the placement portion; and
disposing and joining a closing plate to the tray to close the groove and define a coolant flow path.

6. The method for manufacturing an electric vehicle battery case according to claim 5, wherein the preparing a tray includes:
forming the placement portion having a recessed shape in a blank material having a flat plate shape, and
forming the groove in the bottom portion of the placement portion.

7. The method for manufacturing an electric vehicle battery case according to claim 6, wherein the preparing a tray includes:
forming the placement portion in the blank material by first cold press forming, and
forming the groove in the bottom portion of the placement portion by second cold press forming.

8. The method for manufacturing an electric vehicle battery case according to claim 7, further comprising performing softening heat treatment on the blank material between the first cold press forming and the second cold press forming.

9. The method for manufacturing an electric vehicle battery case according to claim 6, wherein the preparing a tray includes:
forming the placement portion in the blank material and the groove in the bottom portion of the placement portion by a pressure forming method.

10. The method for manufacturing an electric vehicle battery case according to claim 6, wherein the preparing a tray includes:
forming the placement portion in the blank material by cold press forming, and
forming the groove in the bottom portion of the placement portion by a pressure forming method.

11. The method for manufacturing an electric vehicle battery case according to claim 9, wherein the pressure forming method includes:
superposing and disposing a hydraulic transfer elastic body configured to be elastically deformed on the blank material using pressure of liquid, and
pressurizing the blank material via the hydraulic transfer elastic body.

12. The method for manufacturing an electric vehicle battery case according to claim 6,
further comprising preparing a frame configured to define a space inside the frame,
wherein the preparing a tray further includes:
superposing and disposing the blank material on the frame, and
pressurizing and pressing the blank material against the frame to swell the blank material into the space so as to form the blank material into the tray integrated with the frame.

13. The method for manufacturing an electric vehicle battery case according to claim 12, wherein the preparing a tray further includes performing negative angle forming of at least partially forming a negative angle upward from the bottom portion of the tray.

14. The method for manufacturing an electric vehicle battery case according to claim 12,
further comprising preparing a constraining die having a height dimension equal to or larger than a height dimension of the frame and configured to constrain movement of the frame,
wherein the preparing a tray further includes:
fixing and disposing the constraining die outside the frame,
supporting a first outer edge portion of the blank material with the frame and supporting a second outer edge portion outside the first outer edge portion with the constraining die to bend and dispose the blank material so that a height of the blank material decreases from an outer side toward an inner side, and
pressurizing the blank material in a state where the blank material is bent to form the blank material into the tray.

15. The method for manufacturing an electric vehicle battery case according to claim 10, wherein the pressure forming method includes:
superposing and disposing a hydraulic transfer elastic body configured to be elastically deformed on the blank material using pressure of liquid, and
pressurizing the blank material via the hydraulic transfer elastic body.

16. The method for manufacturing an electric vehicle battery case according to claim 7,
further comprising preparing a frame configured to define a space inside the frame,
wherein the preparing a tray further includes:
superposing and disposing the blank material on the frame, and
pressurizing and pressing the blank material against the frame to swell the blank material into the space so as to form the blank material into the tray integrated with the frame.

17. The method for manufacturing an electric vehicle battery case according to claim 8,
further comprising preparing a frame configured to define a space inside the frame,
wherein the preparing a tray further includes:
superposing and disposing the blank material on the frame, and
pressurizing and pressing the blank material against the frame to swell the blank material into the space so as to form the blank material into the tray integrated with the frame.

18. The method for manufacturing an electric vehicle battery case according to claim 9,
further comprising preparing a frame configured to define a space inside the frame,
wherein the preparing a tray further includes:
superposing and disposing the blank material on the frame, and
pressurizing and pressing the blank material against the frame to swell the blank material into the space so as to form the blank material into the tray integrated with the frame.

19. The method for manufacturing an electric vehicle battery case according to claim 16, wherein the preparing a tray further includes performing negative angle forming of at least partially forming a negative angle upward from the bottom portion of the tray.

20. The method for manufacturing an electric vehicle battery case according to claim 17, wherein the preparing a tray further includes performing negative angle forming of at least partially forming a negative angle upward from the bottom portion of the tray.
